(19) United States
(12) Patent Application Publication
(10) Pub. No.: US 2003/0108745 A1
(43) Pub. Date: Jun. 12, 2003

(54) High flash point pitch based impregnant for carbon and graphite and method

(76) Inventor: Thomas Harry Orac, Strongsville, OH (US)

Correspondence Address: UCAR Carbon Company Inc., Brandywine West, Suite 301, 1521 Concord Pike, Wilmington, DE, 19803, US

(21) Appl. No.: 10/013,399

(22) Filed: Dec. 10, 2001

(51) Int. Cl. B32B 9/00

(52) U.S. Cl. 428/408

(57) ABSTRACT

An impregnating pitch having a softening point of about 90° C. and a flash point above about 280° C. is prepared from a coal tar liquid. Preparation of the pitch involves sparging coal tar liquid with steam or an inert gas while maintaining the liquid at a temperature of from about 260° C.-270° C.

### TECHNICAL FIELD

This invention relates to an impregnating pitch useful, for example, in the production of graphite electrodes for the steel industry. Binder and impregnating pitches are conventionally applied to carbon or graphite stock and when subject to carbonization, they decrease the porosity and increase the strength of the underlying carbon or graphite stock.

### BACKGROUND OF THE INVENTION

Carbon and graphite bodies are generally found from mixtures of a binder, such as a pitch, and coke particles. They are generally porous and may lack the mechanical strength required for stressful applications, particularly high stress application such as are encountered by electrodes used in high temperature furnace applications. In order to reduce porosity and thereby increase mechanical strength for use in high stress applications, products made from carbon or graphite stock may require that the underlying carbon or graphite stock be impregnated with a suitable impregnant such as a polymer resin or pitch. The impregnant is chosen such that it will penetrate the stock being treated prior to the impregnated stock being subjected to a carbonizing step, which involves a treatment at sustained high temperatures. Following the carbonizing step, the porosity of impregnated stock is seen to decline and mechanical strength is increased.

For carbonaceous electrodes and other carbon and graphite bodies it is common to use a pitch as the impregnant. Pitch is a complex mixture of polynuclear aromatics generally derived from the thermal treatment of coal tar or a petroleum tar. Typical impregnating pitches have coking values (MCC) (modified Conradson carbon content test as described on page 51, Volume II of “Analytical Methods for Coal and Coal Products”, C. Carr, Jr. Academic Press (1978)) of about 40-50%. However, these typical impregnating pitches are solid at room temperature and must be preheated to high temperature to transform them to a low viscosity liquid suitable for impregnation. It is also conventional to preheat the carbon or graphite electrode stock to an elevated temperature before adding the pitch impregnant. The electrode is then cooled to solidify the impregnant.

After pitch is impregnated into the carbon or graphite body it is normally rebaked to carbonize the impregnant. About ⅓ of a conventional pitch impregnant composition runs out of the carbon body prior to coking thereby decreasing the ultimate impregnant carbon yield after carbonization to about 35%.

In some instance, the product of a first baking step is again impregnated with a pitch, resin or other carbon based composition and subjected to a re-bake which results, inter alia, in a further increase in both density and mechanical strength.

Among the desired properties of a suitable impregnant for use in the manufacture of carbon or graphite bodies is that it does not have a softening point above about 100° C., for higher softening points can result in a porosity which shortens the working life of the product. Porosity can also arise from the volatilization of low molecular weight components in the impregnant. One useful indicia of such a tendency to volatilization for pitches is flash point.

The preparation of a pitch based binder for use in carbon electrode manufacturing processes has been described, for example, in U.S. Pat. No. 4,086,156, wherein the starting material is a bottoms product obtained by steam cracking a petroleum hydrocarbon at a temperature of 700° C. to 1,000° C. This bottoms product, or pitch, is subjected to stripping under reduced pressure to obtain a pitch with an initial boiling point of 350° C.-400° C. at atmospheric pressure. This pitch is then heat soaked in the absence of air at 360° C.-420° C. and then stripped under reduced pressure to obtain a desired pitch based binder with an R and B softening point of 75° C. Another example of a pitch based binder preparation is found in U.S. Pat. No. 4,017,378 wherein the bottoms product or residue obtained from the cracking of naphtha is distilled and thermally aged at atmospheric pressure. Yet another example is found in U.S. Pat. No. 5,507,938 wherein a feed material of carbonaceous tar or pitch is atomized and the resulting aerosol contacted with a flaming, non-reactive gas atmosphere at a temperature of from about 1,400°-2,000° F., followed by the recovery of a fraction of the liquid formed in the reaction vessel.

In another method for making pitch, a charge of coal tar is heated in a batch still until the desired softening point is reached. For an impregnating pitch this will be about 90° C., although it might be higher for various binder pitches. As used herein, unless otherwise indicated, “softening point” shall refer to the Mettler softening point as established by ASTM method D3104-75. During this heating process, coal tar liquid may be sparged with steam. When a product with the desired 90° C. softening point is obtained, the flash point will usually be in a 245° C. to 265° C. range. As used herein, unless otherwise indicated, flash point shall refer to the flash point as measured by the Cleveland Open Cup test. Variations in flash point are influenced by the nature of the starting material, the particular characteristics of the set-up of the equipment, and also by the inherent imprecision in the method for determining the flash point. The process as described above does not allow for varying the flash point of the pitch independently of its softening point.

### SUMMARY OF THE INVENTION

The art has been in need of an impregnating pitch for graphite and carbon stock with a softening point of about 90° C., but with a flash point in excess of about 270° C. However, to achieve flash points in excess of about 270° C. generally requires that the softening point be well in excess of 90° C.

It is an object of this invention to provide a pitch with a relatively low softening point in relation to its flash point.

It is a more specific object of the invention to provide a pitch for a carbon or graphite body wherein the pitch has a softening point of about 90° C. and a flash point in excess of about 280° C.

These and other objects of the invention are accomplished by sparging a hot coal tar liquid with steam or an inert gas at a temperature of between about 260° C. to about 270° C. until the liquid has achieved a softening point of about 90° C. and a flash point above about 280° C.

### DETAILED DESCRIPTION OF THE INVENTION

The impregnating pitch of the present invention may be prepared in a two-step process. In a first step, coal tar liquid is heated in a still, with or without steam stripping, to a temperature of between about 260° C. to 270° C. When heated to the 260° C.-270° C. range, the liquid will have a softening point between about 70° C. and 75° C., and the flash point of this composition will be below about 240° C. At this point, heat being supplied to the still is reduced to the point where heat input is generally balanced with heat loss, i.e., the temperature of the liquid remains constant and no longer increases.

Sparging steam and/or an inert gas, such as nitrogen, is then blown into the liquid, while the temperature is maintained in this range of about 260° C. to about 270° C. Under these conditions both the softening point of the liquid and the flash point will continue to increase, but the flash point will increase at roughly twice the rate at which the softening point will increase. By the time the softening point of the composition has reached a desired 90° C., the flash point will be in excess of about 280° C., and is usually in the range of about 280° C.-300° C.

The following examples are presented to further illustrate and explain the invention and are not intended to be limiting in any regard. Unless otherwise indicated, all parts and percentages are by weight.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are meant to cover the claimed components and steps in any sequence that is effective to meet the objectives there intended, unless the context specifically indicates the contrary.

What is claimed is:

1. A pitch for a carbon or graphite body prepared by sparging a hot coal tar liquid with steam or an inert gas at a temperature of between about 260° C. to about 270° C. until said liquid has a softening point of about 90° C. and the flash point of said liquid is above about 280° C.
